(19) United States
(12) Patent Application Publication
(10) Pub. No.: US 2019/0239650 A1
(43) Pub. Date: Aug. 8, 2019

(54) Bench Seat Lock Box

(71) Applicant: Larry D. Nelson, Caliente, NV (US)

(72) Inventor: Larry D. Nelson, Caliente, NV (US)

(21) Appl. No.: 16/268,339

(22) Filed: Feb. 5, 2019

Related U.S. Application Data
(60) Provisional application No. 62/709,904, filed on Feb. 5, 2018.

(51) Int. Cl. A47C 7/62; E05B 67/38; E05D 3/12; E05B 65/52; A47G 29/14; A47G 29/20; A47C 1/14

(52) U.S. Cl. CPC A47C 7/628; E05B 67/383; E05D 3/12; A47C 1/14; A47G 29/141; A47G 29/20; E05B 65/52

(57) ABSTRACT

An appliance including a storage well or space member configured to be operable for enclosing items or objects; a seat area for supporting an occupant and cover the storage well or space member; a hinge implement for maintaining the seat area in a predetermined position when open; a seat frame configured to support the seat area; a spacing constituent disposed between a back edge of the seat area and a back edge of the seat frame, the spacing constituent allows the seat area to be opened past proximately 90-degrees; a locking means for locking the storage well or space member.

### CROSS-REFERENCE TO RELATED APPLICATIONS

The present Utility patent application claims priority benefit of the [U.S. provisional application for patent Ser. No. 62/709,904 entitled “Bench Seat Lock Box”, filed on Feb. 5, 2018, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to seat structures for safeguarding delivered goods. More particularly, certain embodiments of the invention relate to a seat appliance operable for sitting on with a lockbox for preventing theft of delivered goods.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. The advent of Internet/online shopping in recent years may have created a new dimension of merchandise choice and convenience for consumers. Based on the current trend in consumer shopping and purchasing, estimates are that the Internet/online shopping may be experiencing explosive growth. The Internet may have become a shopping hub in that consumer shopping and purchasing habits may be altered forever. The frenzy of the Internet continues to grow, but not just through its use for social media. The web may have be a favorite place to shop. It's convenient, after all, allowing goods to be purchased from home and then quickly delivered, completing that cycle as simply as possible.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that with the explosive growth in the number of purchases via the Internet, there is an even greater demand for package delivery and pickup services. These services may be a critical element to the overall effectiveness and success of Internet/online shopping experience for both merchandisers and consumers. While the number of consumer orders may be growing at an explosive rate, the number of packages that must be delivered to or picked up from the consumer household or business may be growing exponentially. The rapid growth of Internet/online shopping, the potential for theft or loss may grow substantially, severely restricting merchant package delivery options. For mail order and electronic commerce to continue its growth, customers must be assured of the security of both their payment information and the delivery of their order.

Consumers may not always be home when goods are delivered. This inconvenience subjects packages to theft. The theft of delivered goods from front porches is growing, and is reducing consumer confidence in this shopping and/or delivery method. Exposed packages left on doorsteps, behind bushes or in rear yards may not only be prime targets for theft. Weather conditions may also complicate delivery when a customer is not available to accept a package. During inclement weather, packages may or may not be wrapped in weather proof material and placed in one of the locations described above. Some materials subject packages to potential damage from inclement weather. Weather proof material may add extra costs to the delivery firm. Customers may not want to have their packages left on their doorstep exposed to theft or weather damage while they are out.

As an illustration, a package is delivered, left at the front door because the recipient isn't home, and a thief steals it before the owner can retrieve it. This is common and with the holidays rapidly approaching the rate of occurrence of this already frequent crime is going to soar. These stolen packages result in unhappy recipients, this may be as minor as a disappointed child on Christmas or as serious as the medication a person relies on. These “porch thieves” upset their victims, put people's health at risk, replacement cost can be burdensome, and the common occurrence of this crime may eventually increase delivery costs & shipping insurance rates. The non-financial burdens may be difficult to bear as well (maybe more so) such as disappointing your wife when her anniversary gift doesn't arrive or when your daughter's birthday present is stolen.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary seat appliance with a lockbox, in accordance with an embodiment of the present invention;

FIG. 2 is a back view of the seat appliance and lockbox combination, in accordance with an embodiment of the present invention;

FIG. 3 is an illustration of a seat appliance with an open lockbox, in accordance with an embodiment of the present invention;

FIG. 4 is an illustration of an exemplary hinge implement for holding the seat lid open, in accordance with an embodiment of the present invention;

FIG. 5A is an illustration of an exemplary secured lockbox and FIG. 5B is an illustration of an unsecured lockbox, in accordance with an embodiment of the present invention;

FIG. 6A is an illustration of an exemplary category of a seat appliance and lockbox combination. FIG. 6B is an illustration of an exemplary class of a seat appliance with a lockbox, in accordance with an embodiment of the present invention;

FIG. 7 is an illustration of an exemplary use of a seat appliance with a lockbox, in accordance with an embodiment of the present invention; and

FIG. 8 shows a flowchart of an exemplary use of a seat appliance and a lockbox combination, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention and variations thereof, relate to seat appliances with lockboxes. In one embodiment of the present invention, the seat appliance is configured to be operable for sitting on and the lockbox for preventing theft of delivered goods. The lockbox may include a parcel receptacle disguised and functional as a porch bench that features internal, obtuse-opening hinges that allow the seat lid to be opened past 90-degrees and to self-maintain that open position. In some embodiments, the seat appliance and lockbox combination features a hinged, cushioned lid that may be locked in the down position over a storage well. The locking means may include but are not limited to hasp and padlock, key lock, and digital lock. Lockable aspect of the cushioned lid facilitates homeowner only access, and furthers the theft prevention qualities of the invention. In other embodiments, the seat appliance and lockbox combination may be anchored to a patio, porch or other structure to secure its placement and further the theft prevention qualities of the invention. In another embodiment, a new method of use for a lock box and sitting bench combination that facilitates the secure delivery and pick-up of packages includes but not limited to: Step 1: Place invention on a front porch or other accessible area. Step 2: Place an unlocked lock in staple. Lid/Seat remains unlocked to allow access to a delivery professional. Step 3: Delivery professional places package(s) in the invention and locks the lid. Step 4: When owner notices lid is locked, they'll retrieve the package. Step 5: Owner will leave padlock in staple unlocked and ready for next delivery.

In additional embodiments, the package-securing seat/bench may come in a put-together-yourself kit that may be decorated by the user to match its environment and to further disguise its purpose as a package receptacle. The seat portion may comprise a back rest to generally support a user's back when the user is seated, an armrest on which the user's arm may be placed, an armrest front leg support, a seat portion for sitting on, and a cushion used as a comfortable support for sitting or leaning on including, but not limited to, a fabric stuffed with a mass of soft material. The package-securing portion may comprise a package receptacle disposed on a base of the seat appliance for enclosing items or objects such as, but not limited to, delivered goods. A hinged seat lid for covering or accessing the contents of the package receptacle. A securing means for securing and/or safeguarding the package receptacle. The armrest front leg support coupled with the front upper rail and front lower rail supports the front panel of the package-securing portion.

In some embodiments, the seat and lockbox device may help delivery companies increase consumer satisfaction, consumer confidence, and consumer retentions by ensuring packages are received by the correct person. In addition, the device may prevent consumers from contesting payment for goods that were stolen after delivery, the device may be decorated by an individual user, and to match individual taste and/or environment of use to further enhance the device clandestine use for protection of delivered goods. Further, the device may also be capable of securement to a stable surface, such as by bracket or screw to a porch, which prevents complete theft of the “Bench Seat Lock Box,” which further accentuates its theft prevention capabilities.

In further embodiments, the seat platform and lockbox device combination may be made in various bench designs and with various bench features. The seat platform and lockbox device combination may be made in various sizes and shapes, and may offer various storage capacities. The hinges that secure the seating platform may or may not be internally applied. The bench seat lockbox device combination may or may not include a corresponding padlock in its final packaging, may be secured by various means, such as but not limited to a padlock-accepting hasp-and-staple, a built-in locking mechanism controlled by included key, an electronic locking mechanism controlled by remote control device and/or a personal identification number (PIN), may use a locking cylinder that accepts a key design also used by, and/or is provided to, delivery companies, allowing said delivery companies to independently open and secure delivered goods within the appliance. The bench seat lockbox device may be made in various outdoor furniture formats, such as but not limited to a bench, chair, rocking chair, table, and plant pot and may be provided in formats intended for use in commercial environments. In formats that secures the device by electronic locking mechanism, the remote-control device and/or PIN may or may not be shared with various delivery companies, allowing said companies to access the storage area of the device. In formats that secure the device by built-in locking mechanism, the device may use a locking cylinder that accepts a key design also used by, and/or is provided to, delivery companies, allowing said delivery companies to independently open and secure delivered goods within the appliance.

In some other embodiments, the “Bench Seat Lock Box” may comprise of a seating bench with a backrest and arm rests, designed to accommodate two (2) occupants, and is made of, but not limited to, a durable wood material. The seating area of the bench may be fully enclosed, and measures approximately forty-eight inches in width by twenty inches in height by twenty-four inches in depth (48″×20″×24″). Sidewalls that form the arm rests are raised an approximate nine inches (9″) in height from the seating area base, and a back plane is raised approximately twenty inches (20″) from the seating area base. The top plane of the seating area may be attached by internal hinges. Said hinges allow for the seat lid to be raised to an extent greater than 90-degrees from the bench surface, and to self-maintain that open position to manually close. A cushion, made of durable foam and enclosed within a weather-proof lining may be placed upon the top surface of the seating area. Centered on the forward edge of the seating area is a hasp. The hasp may correspond with a staple, which is applied in synchronous position on the front facing plane of the “Bench Seat Lock Box.”

In a usage embodiment, after applying the “Bench Seat Lock Box” to a location of use, a user may apply an unlocked securing device, such as a key-operated padlock, to the staple of the appliance. The “Bench Seat Lock Box” may then accept deliveries at any time, even when the user is not present for such deliveries. The deliverer may simply raise the hinged lid of the seating area, then deposit the goods within the enclosed portion of said seating area. The deliverer may then remove the padlock from the staple, secure the hasp over the staple, then insert and lock the padlock within the hasp-hosting staple. When the user returns to the location of the “Bench Seat Lock Box,” user may simply insert the key within the padlock to open it, then raise the hinged lid to access the delivered goods. The “Bench Seat Lock Box” may also be used at any time as a comfortable outdoor-furniture bench.

The present invention will now be described in detail with reference to embodiments thereof as illustrated in the accompanying drawings.

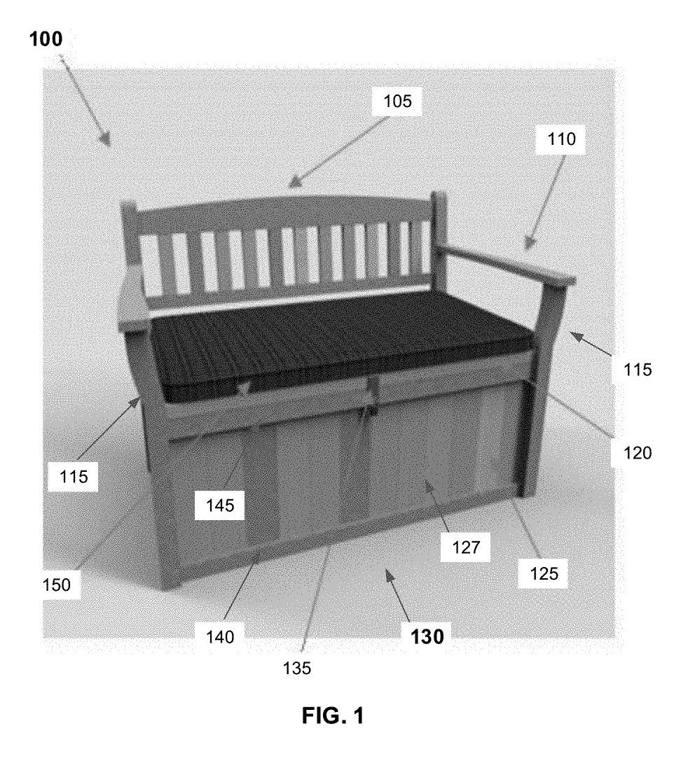

FIG. 1 is an illustration of an exemplary combination seat appliance 100 and lockbox device 130, in accordance with an embodiment of the present invention. In the embodiment shown, the seat appliance 100 is configured to be operable for sitting on. The lockbox is configured to prevent theft of delivered goods. The seat appliance 100 may comprise of a back rest 105 to generally support a user's back when the user is seated, an armrest 110 on which the user's arm may rest, an armrest front leg support 115, a seat area/lid 120 for sitting on. A cushion implement 150 may be placed upon the top surface of the seat area/lid 120 which may be used as a comfortable support for sitting or leaning on including, but not limited to, a fabric stuffed with a mass of soft material and/or a durable foam enclosed within a weather-proof lining, etc. The lockbox 130 may comprise of a storage well/space 125 disposed on a base of the seat appliance 100 for enclosing items or objects such as, but not limited to, delivered goods. The seat area/lid 120 for covering or accessing the contents of the storage well/space 125. A securing/locking means 135 for securing and/or safeguarding the storage well/space 125. The securing/locking means 135 may include, but not limited to, a hasp and padlock, a key lock, a digital lock, a built-in locking mechanism controlled by key, an electronic locking mechanism controlled by remote control device and/or a personal identification number (PIN), etc. An armrest front leg support 115 coupled with the front upper rail 145 and front lower rail 145 supports the front panel 127 of the lockbox 130. The seating area 120 of the seat appliance 100 may be fully enclosed, and may measure approximately forty-eight inches in width by twenty inches in height by twenty-four inches in depth (48″×20″×24″). Sidewalls that surrounds the armrest front leg support 115 may be raised an approximate nine inches (9″) in height from the base of the seating area 120, and a back plane may be raised approximately twenty inches (20″) from the seating area 120 base. The top plane of the seating area 120 may be attached by internal hinges. The hinges may allow for the seat area/lid 120 to be raised to an extent greater than 90-degrees from the surface of the seating area, and to self-maintain that open position until manually closed.

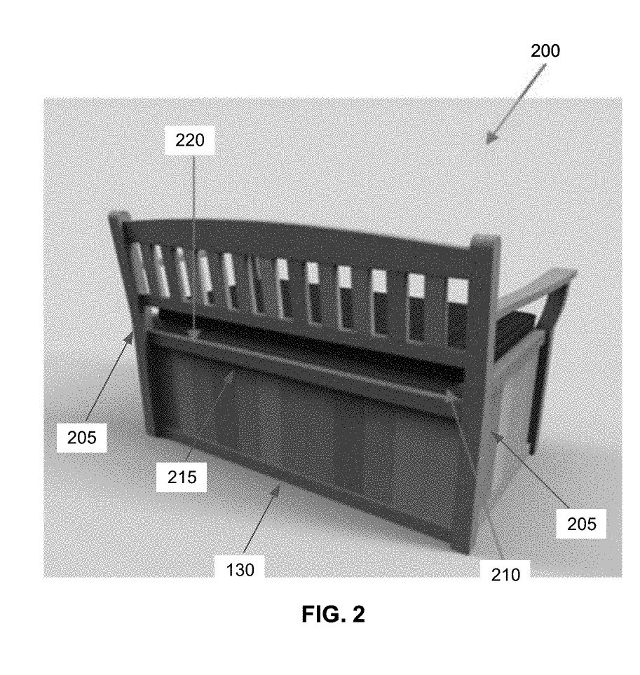

FIG. 2 is a back view 200 of the combination seat appliance 100 and lockbox device 130, in accordance with an embodiment of the present invention. In the embodiment shown, the seat appliance 100 may further comprise of a rear leg support 205, a back edge of the seat lid 210, a back edge of the seat frame 215, and a spacing constituent 220 disposed between the back edge of the seat lid 210 and the back edge of the seat frame 215. The spacing constituent 220 may allow the seat 115 to open past 90-degrees. The spacing constituent 220 may comprise of a couple of inches including, but not a limitation, two inches, three inches, etc.

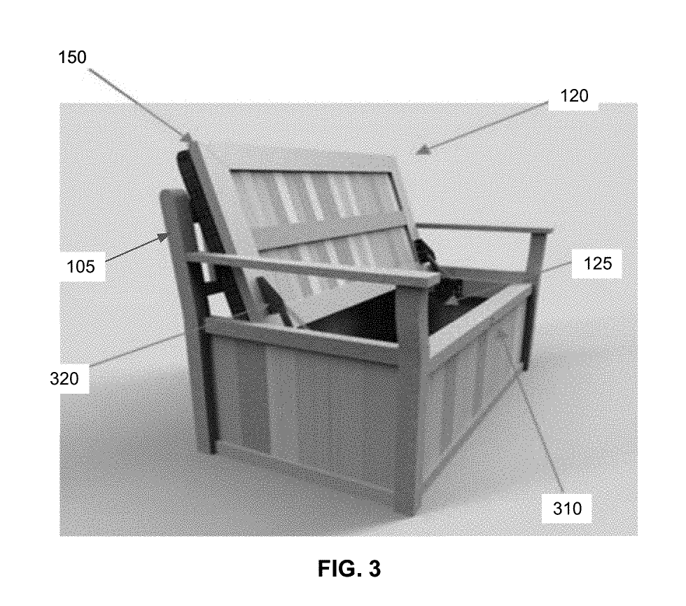

FIG. 3 is an illustration of a seat appliance 100 with an open lockbox 130, in accordance with an embodiment of the present invention. In the embodiment shown, the top plane of the seating area 120 may be attached by a hinge implement 320. The hinge implement 320 may allow for the seat area/lid 120 to be raised to an extent greater than 90-degrees from the surface of the seating area, and to self-maintain that open position to manually close. The seat area/lid 120 may be opened past 90 degrees and no one has to hold it open which may make it easy to deposit and retrieve packages in the lockbox 130 using both hands. In one embodiment, the seat appliance may further comprise of a staple 310, a hinge implement 320 that may allow and hold the seat area/lid 120 to open without support from a user, and the cushion 150 softens the effect of an impact of the opened seat area/lid 120 against the back rest 105. The hinge implement 320 may include, but not limited to, an obtuse hinge implement, barrel hinges, top flap hinges, pivot hinges, etc.

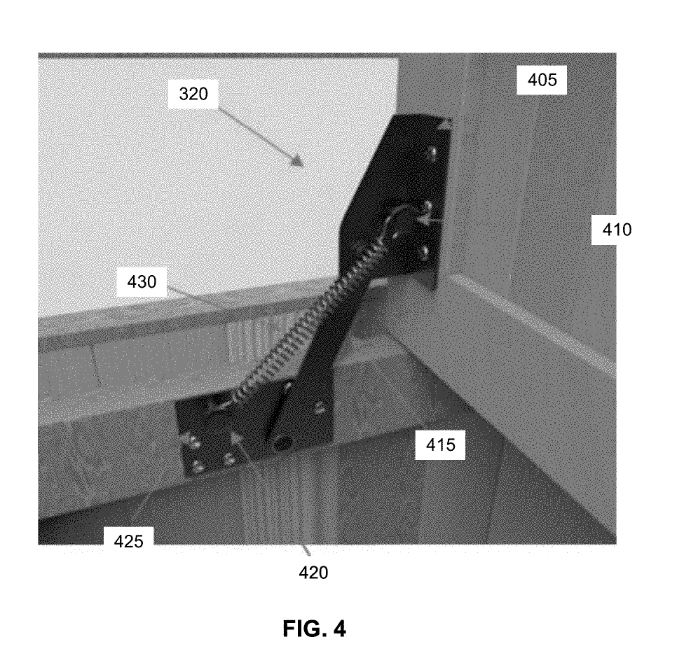

FIG. 4 is an illustration of an exemplary hinge implement 320, in accordance with an embodiment of the present invention. In the embodiment shown, the hinge implement 320 may comprise of a hinge mounting bracket 405, a bracket side spring-mounting module 410, a stabilizing shaft 415, a plate side spring-mounting module 420, a hinge mounting plate 425, and a spring implement 430.

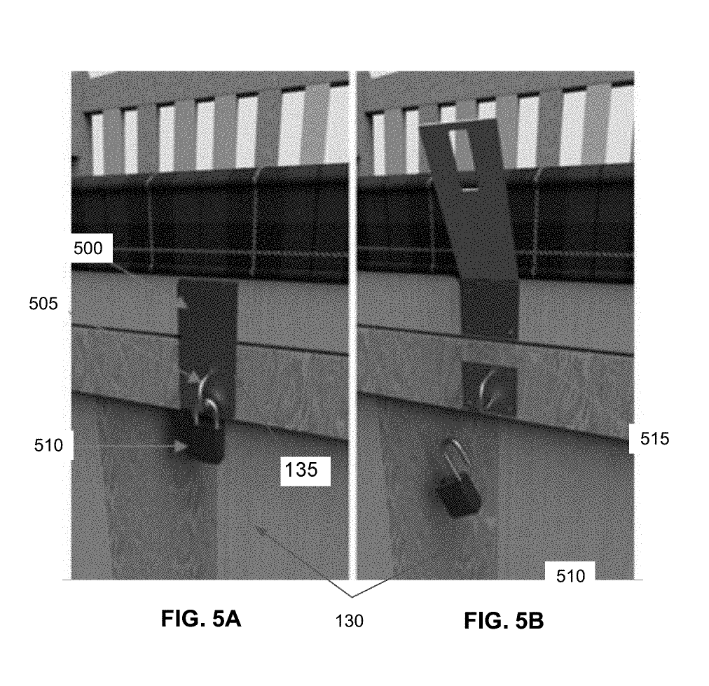

FIG. 5A is an illustration of an exemplary securing/locking means 135 securing the lockbox 130. FIG. 5B is an illustration of an unsecured lockbox, in accordance with an embodiment of the present invention. In the embodiment shown, in FIG. 5A, the securing/locking means 135 is in a secured state, and in FIG. 5B, the securing/locking means 135 is in an unsecured state. The securing/locking means 135 may comprise of a hasp 500, a staple 505, and a padlock 510. Alternatively, the securing/locking means 135 may include, but not limited to, a key lock, a digital lock, a built-in locking mechanism controlled by key, an electronic locking mechanism controlled by remote control device and/or a personal identification number (PIN), etc. In formats that secure the lockbox by a built-in locking mechanism, the “Bench Seat Lock Box” may use a locking cylinder that accepts a key design also used by, and/or is provided to, delivery companies, allowing the delivery companies to independently open and secure delivered goods within the lockbox. In formats that secure by electronic locking mechanism, the remote-control device and/or PIN may or may not be shared with various delivery companies, allowing said companies to access the storage area of the “Bench Seat Lock Box.”

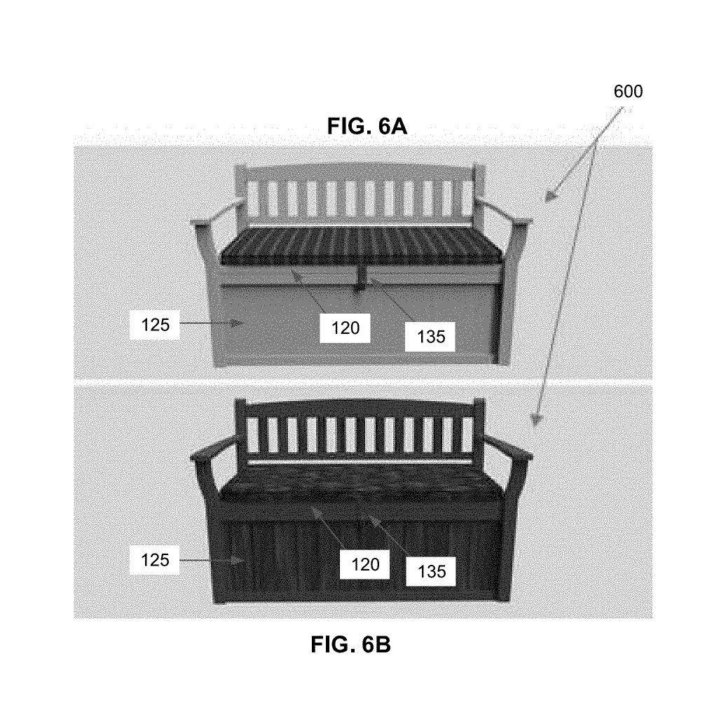

FIG. 6A and FIG. 6B is an illustration of an exemplary seat appliance with a lockbox, in accordance with an embodiment of the present invention. In the embodiment shown, FIG. 6A illustrates a class of seat structures with lockboxes. FIG. 6B illustrates another class of seat structures with lockboxes. The embodiment shown in FIGS. 6A and 6B may comprise of a user-assembled kit that may be decorated to match an area of use, including but not limited to, a gray porch, a brick house, etc. The user-assembled kit can come in any color such as white, black, blue, camouflage, pastels, etc. The cushion can be of various thicknesses such as ½″ to 3″. The cushion can feature a covering of various solid or mixed colors to include theme designs. The colors may be but are not limited to white, black, blue, green, brown, pastels and any combination of those and other colors. Additionally, the cushion and the seat structure may have a themed design and color scheme such as, but not limited to, for Christmas, Thanksgiving, Easter, Spring, Fall, etc. The seating structure may come as a person bench, a multi-person bench, a chair, a stool, etc.

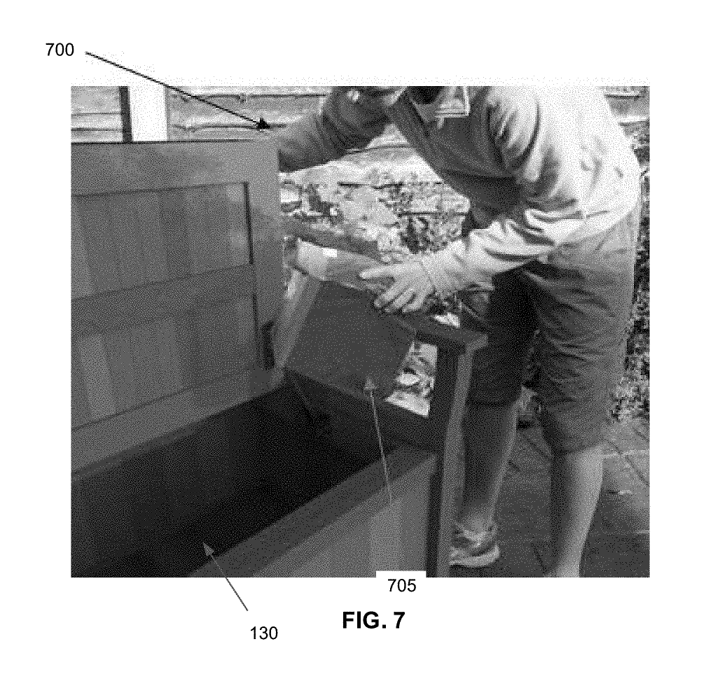

FIG. 7 is an illustration of an exemplary use of a seat appliance with a lockbox device, in accordance with an embodiment of the present invention. In the illustration shown, a user 700 is retrieving a delivered package 705 from the lockbox device.

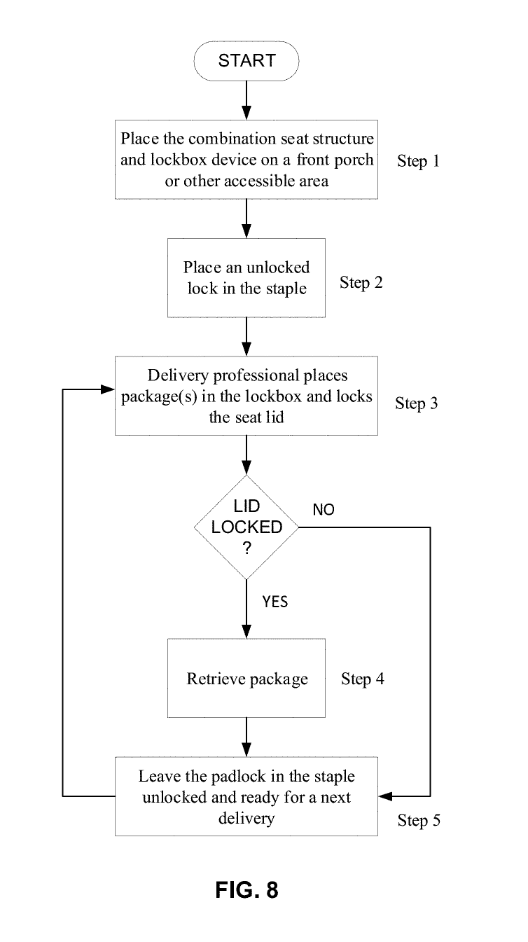

FIG. 8 shows a flowchart of an exemplary use of a combination seat appliance and lockbox device, in accordance with an embodiment of the present invention. In Step 1: Place the combination seat appliance and lockbox device on a front porch or other accessible area. In Step 2: Place an unlocked lock in the staple. The seat lid may remain unlocked to allow access to a delivery professional. In Step 3: A delivery professional places package(s) in the lockbox and locks the seat lid. The lockbox device may be locked and secured after its receipt of the delivered package(s) where the padlock is secured to the hasp and staple. In Step 4: When the seat lid is locked, it may be an indication that a package has been delivered and to retrieve the package. In Step 5: Leave the padlock in the staple unlocked and ready for a next delivery.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post MA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post MA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post MA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a combination seat structure and lockbox device according to the present invention will be apparent to those skilled in the art. Various aspects of the invention have been described above by way of illustration, and the specific embodiments disclosed are not intended to limit the invention to the particular forms disclosed. The particular implementation of the combination seat structure and lockbox device may vary depending upon the particular context or application. By way of example, and not limitation, the combination seat structure and lockbox device described in the foregoing were principally directed to package delivery implementations; however, similar techniques may instead be applied to mail, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. An appliance comprising:
a storage well or space member, said storage well or space member is configured to be operable for enclosing items or objects;
a seat area, wherein said seat area is configured to support an occupant and cover said storage well or space member;
a hinge implement, said hinge implement is configured to maintain said seat area in a predetermined position when open;
a seat frame, said seat frame is configured to support said seat area;
a spacing constituent disposed between a back edge of the seat area and a back edge of said seat frame, said spacing constituent is configured to allow said seat area to be opened past proximately 90-degrees; and
a locking means that is configured to lock said storage well or space member.

2. The appliance of claim 1, further comprising a back rest section, said back rest section is configured to support an occupant's back when the occupant is seated.

3. The appliance of claim 2, further comprising an armrest element that is operable for supporting an occupant's arm.

4. The appliance of claim 3, further comprising a cushion implement, said cushion implement comprises a durable foam enclosed within a weather-proof lining.

5. The appliance of claim 4, in which said armrest element comprises at least two armrest front leg support.

6. The appliance of claim 5, further comprising an armrest front leg support component.

7. The appliance of claim 6, in which said locking means comprises at least a hasp and a padlock.

8. The appliance of claim 7, in which said locking means comprises at least a digital lock.

9. The appliance of claim 7, in which said locking means comprises at least a built-in locking mechanism controlled by key.

10. The appliance of claim 7, in which said armrest front leg support component comprises at least two armrest front leg support.

11. The appliance of claim 7, in which said locking means comprises at least an electronic locking mechanism controlled by remote control device.

12. The appliance of claim 7, in which said locking means comprises at least an electronic locking mechanism controlled by a personal identification number (PIN).

13. The appliance of claim 4, in which said hinge implement comprises:
a hinge mounting bracket;
a stabilizing shaft;
a hinge mounting plate; and
a spring implement.

14. The appliance of claim 13, in which said hinge implement further comprises:
a bracket side spring-mounting module; and
a plate side spring-mounting module.

15. An appliance consisting of:
means for enclosing items or objects;
means for covering said enclosing means;
means for maintaining said covering means in an open position;
means for supporting said covering means;
means for allowing said covering means to be opened past proximately 90-degrees;
means for locking said covering means;
means for supporting an occupant's back when the occupant is seated; and
means for supporting the occupant's arm.

16. An appliance comprising:
a storage well or space member, said storage well or space member is configured to be operable for enclosing items or objects;
a seat area, wherein said seat area is configured to support an occupant and cover said storage well or space member;
a hinge implement, said hinge implement is configured to maintain said seat area in a predetermined position when open;
a seat frame, said seat frame is configured to support said seat area;
a spacing constituent disposed between a back edge of the seat area and a back edge of said seat frame, said spacing constituent is configured to allow said seat area to be opened past proximately 90-degrees;
a locking means that is configured to lock said storage well or space member;
a back rest section, said back rest section is configured to support an occupant's back when the occupant is seated;
an armrest element that is operable for supporting an occupant's arm; and
an armrest front leg support component that is configured to support said armrest element.

17. The appliance of claim 16, further comprising a cushion implement, said cushion implement comprises a durable foam enclosed within a weather-proof lining.

18. The appliance of claim 17, in which said armrest element comprises at least two armrest front leg support.
a hinge mounting bracket;
a stabilizing shaft;
a hinge mounting plate;
a spring implement;
a bracket side spring-mounting module; and
a plate side spring-mounting module.

19. The appliance of claim 18, further comprising an armrest front leg support component.

20. The appliance of claim 19, further comprising steps of using said appliance, wherein said steps of using said appliance comprises:
placing a combination seat structure and lockbox device on a front porch or other accessible area;
unlocking said seat structure to allow access to said lockbox device by a delivery professional;
receiving a delivered package; and
leaving a padlock in a staple unlocked ready for a next delivery.
